(19) United States
(12) Patent Application Publication
(10) Pub. No.: US 2005/0230247 A1
(43) Pub. Date: Oct. 20, 2005

(54) Multilayered gas sensing element

(75) Inventors: Shinichiro Imamura, Chiryu-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/091,759

(22) Filed: Mar. 29, 2005

(30) Foreign Application Priority Data
Apr. 15, 2004 (JP) 2004-120684

(51) Int. Cl. G01N 27/26

(52) U.S. Cl. 204/424; 204/426

(57) ABSTRACT

A heater substrate contains insulating ceramic. Each of first and second solid electrolytic substrates contains first and second components. A thermal expansion coefficient of the second component is different from a thermal expansion coefficient of the insulating ceramic by an amount equal to or less than 2.0×10⁻⁶° C.⁻¹. A second component content of the first solid electrolytic substrate is different from an insulating ceramic content of the heater substrate by an amount equal to or less than 90 wt. %. A second component content of the second solid electrolytic substrate is different from the second component content of the first solid electrolytic substrate by an amount equal to or greater than 10 wt. %. The second component content of the first or second solid electrolytic substrate is equal to or less than 80 wt. %.

### CROSS-REFERENCE TO RELATED APPLICATION

This application is based upon and claims the benefit of priority from earlier Japanese Patent Application No. 2004-120684 filed on Apr. 15, 2004 so that the description of which is incorporated herein by reference.

### BACKGROUND OF THE INVENTION

The present invention relates to a multilayered gas sensing element including a sensor cell detecting the concentration of a specific gas from exhaust gas of an automotive vehicle, a pump cell controlling the concentration of the specific gas supplied to the sensor cell, and a ceramic heater which are integrally laminated together.

It is conventionally known that a multilayered gas sensing element includes a sensor cell detecting the concentration of a specific gas in an exhaust gas, a pump cell controlling the concentration of the specific gas supplied to the sensor cell, and a ceramic heater integrally laminated together. Each of the sensor cell and the pump cell consists of a pair of electrodes provided on both surfaces of a solid electrolytic substrate containing zirconia or the like as a main component. On the other hand, the ceramic heater includes a heater pattern embedded in a heater substrate containing alumina or comparable insulating ceramic as a main component.

In short, the solid electrolytic substrate and the heater substrate laminated with each other to arrange the multilayered gas sensing element are made of different materials. Thus, there is the possibility that warpage or crack may occur in a multilayered gas sensing element during the sintering operation due to the difference of shrinkage factors of these different materials. To solve this drawback, the Japanese Patent Application Laid-open No. 2003-294697 proposes adding alumina or comparable insulating ceramic to the solid electrolytic substrate. The alumina or comparable insulating ceramic is the main component of the heater substrate, it is thus expected that the difference of heat shrinkage factors of the solid electrolytic substrate and the heater substrate can be reduced.

However, adding the insulating ceramic into the solid electrolytic substrate will lessen the ionic conductivity (i.e. electrolytic conductivity) of the solid electrolytic substrate and accordingly will reduce an output current of the sensor cell. On the other hand, lowering the content of the insulating ceramic contained in the solid electrolytic substrate will not be able to sufficiently suppress warpage or crack occurring in the multilayered gas sensing element.

### SUMMARY OF THE INVENTION

In view of the above-described problems of the prior art, the present invention has an object to provide a multilayered gas sensing element capable of suppressing warpage or crack and also securing satisfactory sensor output.

In order to accomplish the above and other related objects, the present invention provides a first multilayered gas sensing element including a ceramic heater, a first cell, and a second cell which are laminated integrally. The ceramic heater has a heater substrate containing an insulating ceramic as a main component. The first cell has a first solid electrolytic substrate containing a first component serving as a main component of an ionic conductive solid electrolyte. And, the second cell has a second solid electrolytic substrate containing the first component. According to the first multilayered gas sensing element of the present invention, each of the first solid electrolytic substrate and the second solid electrolytic substrate contains a second component. A thermal expansion coefficient of the second component is different from a thermal expansion coefficient of the insulating ceramic by an amount equal to or less than 2.0×10⁻⁶° C.⁻¹. The difference between the content of the second component contained in the first solid electrolytic substrate and the content of the insulating ceramic contained in the heater substrate is equal to or less than 90 wt. %. The difference between the content of the second component contained in the second solid electrolytic substrate and the content of the second component contained in the first solid electrolytic substrate is equal to or greater than 10 wt. %. And, the content of the second component contained in at least one of the first solid electrolytic substrate and the second solid electrolytic substrate is equal to or less than 80 wt. %.

The first multilayered gas sensing element of the present invention brings the following functions and effects.

The difference between the content of the second component contained in the first solid electrolytic substrate and the content of the insulating ceramic contained in the heater substrate is equal to or less than 90 wt. %. Accordingly, the present invention can increase the strength of the first solid electrolytic substrate and also can reduce or relax the stress concentrating between the first solid electrolytic substrate and the heater substrate. Thus, the present invention can effectively suppress warpage or crack occurring in the multilayered gas sensing element.

Furthermore, the difference between the content of the second component contained in the second solid electrolytic substrate and the content of the second component contained in the first solid electrolytic substrate is equal to or larger than 10 wt. %. Accordingly, a significant stress acts between the first solid electrolytic substrate and the second solid electrolytic substrate. This is effective in decentralizing a stress generating in the multilayered gas sensing element.

More specifically, if the content of the second component contained in the second solid electrolytic substrate is substantially equal to the content of the second component contained in the first solid electrolytic substrate, there will be the possibility that almost all of the stress concentrates between the heater substrate and the first solid electrolytic substrate.

Hence, as described above, differentiating the content of the second component contained in the second solid electrolytic substrate from the content of the second component contained in the first solid electrolytic substrate can bring the effect of relaxing the stress concentration and suppressing the generation of warpage or crack.

Furthermore, the content of the second component contained in at least one of the first solid electrolytic substrate and the second solid electrolytic substrate is equal to or less than 80 wt. %. Accordingly, it becomes possible to maintain sufficient ionic conductivity in at least one of the first solid electrolytic substrate and the second solid electrolytic substrate and secure sufficient sensor output of the multilayered gas sensing element.

As described above, the present invention can provide a multilayered gas sensing element capable of suppressing warpage or crack and also securing sufficient sensor output.

The functions and effects of the present invention will be explained in more detail in the description of preferred embodiments of the present invention.

Furthermore, in order to accomplish the above and other related objects, the present invention provides a second multilayered gas sensing element including a ceramic heater, a first cell, and a second cell which are laminated integrally. The ceramic heater has a heater substrate containing an insulating ceramic as a main component. The first cell has a first solid electrolytic substrate containing a first component serving as a main component of an ionic conductive solid electrolyte. And, the second cell has a second solid electrolytic substrate containing the first component. According to the second multilayered gas sensing element of the present invention, the heater substrate has a first component containing layer at a position closest to the first solid electrolytic substrate. And, the first component containing layer contains the first component.

According to the second multilayered gas sensing element of the present invention, it becomes possible to reduce the difference between heat shrinkage factors of the first solid electrolytic substrate and the heater substrate. Thus, the second multilayered gas sensing element of the present invention can suppress warpage or crack.

### BRIEF DESCRIPTION OF THE DRAWINGS

The above and other objects, features and advantages of the present invention will become more apparent from the following detailed description which is to be read in conjunction with the accompanying drawings, in which:

FIG. 1 is a cross-sectional view showing a multilayered gas sensing element in accordance with a first embodiment of the present invention;

FIG. 2 is a graph showing the relationship between the insulating ceramic content and the strength of the first solid electrolytic substrate in accordance with the first embodiment of the present invention;

FIG. 3 is a graph showing the stress acting between the first solid electrolytic substrate and the heater substrate in relation to the difference between insulating ceramic contents of the first solid electrolytic substrate and the heater substrate in accordance with the first embodiment of the present invention;

FIG. 4 is a graph showing the crack generation probability in the multilayered gas sensing element in relation to the difference between insulating ceramic contents of the first solid electrolytic substrate and the heater substrate in accordance with the first embodiment of the present invention;

FIG. 5 is a graph showing the stress acting in multilayered gas sensing element in relation to the difference between insulating ceramic contents of the first solid electrolytic substrate and the second solid electrolytic substrate in accordance with the first embodiment of the present invention;

FIG. 6 is a graph showing the relationship between the alumina content and the oxygen ionic conductivity of the solid electrolytic substrate in accordance with the first embodiment of the present invention;

FIG. 7 is a graph showing the relationship between the thickness of the solid electrolytic substrate and the activation time of the first or second cell in accordance with the first embodiment of the present invention;

FIG. 8 is a cross-sectional view showing a multilayered gas sensing element in accordance with a second embodiment of the present invention;

FIG. 9 is a cross-sectional view showing a multilayered gas sensing element in accordance with a third embodiment of the present invention;

FIG. 10 is a cross-sectional view showing a multilayered gas sensing element in accordance with a fourth embodiment of the present invention;

FIG. 11 is a graph showing the relationship between the alumina content of the solid electrolytic substrate and the thickness of the solid electrolytic substrate required to obtain a predetermined sensor output in accordance with the fourth embodiment of the present invention; and

FIG. 12 is a graph showing the distribution of strengths of tested multilayered gas sensing elements.

### DESCRIPTION OF THE PREFERRED EMBODIMENTS

As a best mode for embodying the present invention, the inventors of this application provide a first multilayered gas sensing element including a ceramic heater, a first cell, and a second cell which are laminated integrally. The ceramic heater has a heater substrate containing an insulating ceramic as a main component. The first cell has a first solid electrolytic substrate containing a first component serving as a main component of an ionic conductive solid electrolyte. And, the second cell has a second solid electrolytic substrate containing the first component. According to the first multilayered gas sensing element of the present invention, each of the first solid electrolytic substrate and the second solid electrolytic substrate contains a second component. A thermal expansion coefficient of the second component is different from a thermal expansion coefficient of the insulating ceramic by an amount equal to or less than 2.0×10⁻⁶° C.⁻¹. The difference between the content of the second component contained in the first solid electrolytic substrate and the content of the insulating ceramic contained in the heater substrate is equal to or less than 90 wt. %. The difference between the content of the second component contained in the second solid electrolytic substrate and the content of the second component contained in the first solid electrolytic substrate is equal to or greater than 10 wt. %. And, the content of the second component contained in at least one of the first solid electrolytic substrate and the second solid electrolytic substrate is equal to or less than 80 wt. %.

According to the first multilayered gas sensing element of the present invention, the first component is a main component of an ionic conductive solid electrolyte, such as zirconia, barium oxide, and lanthanum oxide. Furthermore, the insulating ceramic is, for example, the ceramic having electric conductivity equal to or less than 10⁻¹⁸ Ω⁻¹ cm⁻¹ at a room temperature (25° C.), such as alumina, mullite, spinel, and steatite.

Furthermore, the insulating ceramic (for example, in the case of alumina) has a thermal expansion coefficient of 8.0×10⁻⁶° C.⁻¹. There should be a thermal expansion coefficient difference of 2.0×10⁻⁶° C.⁻¹ or less between the insulating ceramic (i.e. alumina) and the second component. The second component is, for example, the same as the insulating ceramic. The second component is selectable from the group of alumina, mullite, spinel, and steatite.

If the thermal expansion coefficient difference between the insulating ceramic and the second component exceeds 2.0×10⁻⁶° C.⁻¹, there will be the possibility that the effects of the present invention cannot be obtained.

For example, the first cell or the second cell is a sensor cell having a measured gas side electrode provided on one surface of the solid electrolytic substrate and a reference gas side electrode provided on the other surface of the solid electrolytic substrate. The measured gas side electrode is exposed to a measured gas. The reference gas side electrode is exposed to a reference gas. Otherwise, the first cell or the second cell is a pump cell having a pair of pump electrodes provided on both surfaces of the solid electrolytic substrate, which is capable of shifting a specific gas between them. Furthermore, it is preferable to dispose a gas-permeable diffusion layer on a surface of the second cell which is far from the ceramic heater.

Furthermore, when the difference between the content of the second component contained in the first solid electrolytic substrate and the content of the insulating ceramic contained in the heater substrate is greater than 90 wt. %, it will be difficult to suppress warpage or crack occurring in the multilayered gas sensing element.

When the difference between the content of the second component contained in the second solid electrolytic substrate and the content of the second component of first solid electrolytic substrate is less than 10 wt. %, it will be difficult to suppress the stress concentrating between the heater substrate and the first solid electrolytic substrate. There will be the possibility that the multilayered gas sensing element may cause warpage or crack.

Furthermore, when the content of the second component contained in both of the first and second solid electrolytic substrates exceeds 80 wt. %, there will the possibility that the multilayered gas sensing element cannot obtain sufficient sensor output.

Furthermore, according to the first multilayered gas sensing element, it is preferable that a difference between the content of the second component contained in the first solid electrolytic substrate and the content of the insulating ceramic contained in the heater substrate is equal to or less than 70 wt. %. According to this arrangement, it becomes possible to suppress warpage or crack occurring in the multilayered gas sensing element.

Furthermore, according to the first multilayered gas sensing element, it is preferable that the difference between the content of the second component contained in the first solid electrolytic substrate and the content of the insulating ceramic contained in the heater substrate is equal to or less than 50 wt. %. According to this arrangement, it becomes possible to further suppress warpage or crack occurring in the multilayered gas sensing element.

Furthermore, according to the first multilayered gas sensing element, it is preferable that the difference between the content of the second component contained in the second solid electrolytic substrate and the content of the second component contained in the first solid electrolytic substrate is equal to or greater than 20 wt. %. This arrangement can effectively relax the stress concentrating between the heater substrate and the first solid electrolytic substrate, and accordingly can further suppress the generation of warpage or crack.

Furthermore, according to the first multilayered gas sensing element, it is preferable that the heater substrate contains the insulating ceramic by an amount equal to or greater than 50 wt. %. According to this arrangement, the heater substrate can secure sufficient insulation properties. When the content of the insulating ceramic is less than 50 wt. %, it will be difficult to sufficiently secure insulation properties of the heater substrate. It will be difficult to obtain an accurate sensor output due to adverse influence of the current flowing in the ceramic heater.

Furthermore, according to the first multilayered gas sensing element, it is preferable that the first cell is a pump cell having a pair of pump electrodes provided on both surfaces of the first solid electrolytic substrate to cause a specific gas to shift between the pump electrodes, and the heater substrate has a passage extending from the pump electrode to an outside of the multilayered gas sensing element. According to this arrangement, it becomes possible to provide a multilayered gas sensing element capable of suppressing warpage or crack and securing sufficient sensor output.

Furthermore, as a best mode for embodying the present invention, the inventors of this application provide a second multilayered gas sensing element including a ceramic heater, a first cell, and a second cell which are laminated integrally. The ceramic heater has a heater substrate containing an insulating ceramic as a main component. The first cell has a first solid electrolytic substrate containing a first component serving as a main component of an ionic conductive solid electrolyte. And, the second cell has a second solid electrolytic substrate containing the first component. According to the second multilayered gas sensing element of the present invention, the heater substrate has a first component containing layer at a position closest to the first solid electrolytic substrate. And, the first component containing layer contains the first component.

For example, the first component containing layer of the second multilayered gas sensing element has the thickness of 3 to 600 μm. According to the second multilayered gas sensing element of the present invention, it is preferable that the content of the first component contained in the first component containing layer is 2 to 40 wt. %. According to this arrangement, it becomes possible to sufficiently secure insulation properties of the heater substrate and suppress warpage or exfoliation (separation) occurring in the multilayered gas sensing element.

When the content of the first component contained in the first component containing layer is less than 2 wt. %, it will be difficult to sufficiently suppress warpage or exfoliation (separation) occurring in the multilayered gas sensing element. On the other hand, when the content of the first component contained in the first component containing layer exceeds 40 wt. %, it will be difficult to sufficiently secure the insulation properties of the heater substrate. Furthermore, it will be difficult to obtain an accurate sensor output due to adverse influence of the current flowing in the ceramic heater.

According to the first or second multilayered gas sensing element of the present invention, it is preferable that the first solid electrolytic substrate has the thickness of 10 to 500 μm. According to this arrangement, the multilayered gas sensing element can be promptly activated.

When the thickness of the first solid electrolytic substrate is less than 10 μm, it will be difficult to form the first solid electrolytic substrate. On the other hand, when the thickness of the first solid electrolytic substrate exceeds 500 μm, the multilayered gas sensing element will not be promptly activated.

According to the first or second multilayered gas sensing element of the present invention, it is preferable that the second solid electrolytic substrate has the thickness of 10 to 500 μm. According to this arrangement, the multilayered gas sensing element can be promptly activated.

When the thickness of the second solid electrolytic substrate is less than 10 μm, it will be difficult to form the first solid electrolytic substrate. On the other hand, when the thickness of the second solid electrolytic substrate exceeds 500 μm, the multilayered gas sensing element will not be promptly activated.

Hereinafter, preferred embodiments of the present invention will be explained with reference to attached drawings.

### First Embodiment

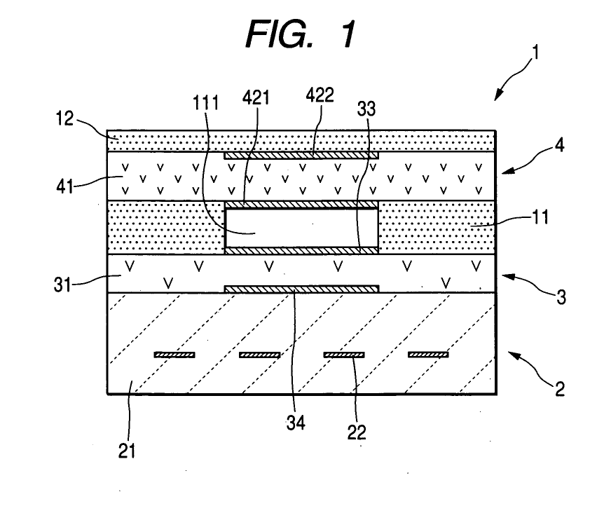

A multilayered gas sensing element in accordance with a first embodiment of the present invention will be explained with reference to FIGS. 1 to 7. The multilayered gas sensing element 1 of this embodiment, as shown in FIG. 1, includes a ceramic heater 2, a first cell 3, a chamber layer 11, and a second cell 4 which are integrally laminated in this order. The ceramic heater 2 includes a heater substrate 21. The first cell 3 includes a first solid electrolytic substrate 31. The chamber layer 11 forms a measured gas chamber 111. And, the second cell 4 includes a second solid electrolytic substrate 41.

The heater substrate 21 contains alumina (i.e. insulating ceramic) as a main component. Furthermore, each of the first solid electrolytic substrate 31 and the second solid electrolytic substrate 41 contains zirconia as a main component (i.e. first component) of the ionic conductive solid electrolyte. According to this embodiment, it is possible to use barium oxide or lanthanum oxide as the first component of the first and second solid electrolytic substrates 31 and 41. It is also possible to use mullite, spinel, or steatite as the insulating ceramic of the heater substrate 21.

Each of the first solid electrolytic substrate 31 and the second solid electrolytic substrate 41 contains a second component. A thermal expansion coefficient of the second component is different from a thermal expansion coefficient of the insulating ceramic (alumina) by an amount equal to or less than 2.0×10⁻⁶° C.⁻¹. The second component of this embodiment is alumina and is the same component as the insulating ceramic which is, for example, selected from the group of alumina, mullite, spinel, and steatite.

The difference between the second component (i.e. alumina) content of the first solid electrolytic substrate 31 and the insulating ceramic (alumina) content of the heater substrate 21 is equal to or less than 90 wt. %, preferably equal to or less than 70 wt. %, and more preferably equal to or less than 50 wt. %.

Furthermore, the difference between the second component (i.e. alumina) content of the second solid electrolytic substrate 41 and the second component (i.e. alumina) content of first solid electrolytic substrate 31 is equal to or greater than 10 wt. %, and preferably equal to or greater than 20 wt. %.

Moreover, the second component (i.e. alumina) content of at least one of the first solid electrolytic substrate 31 and the second solid electrolytic substrate 41 is equal to or less than 80 wt. %, and preferably equal to or less than 50 wt. %. Furthermore, the heater substrate 21 contains alumina by 50 wt. % or more. Furthermore, each of the first solid electrolytic substrate 31 and the second solid electrolytic substrate 41 has the thickness of 10 to 500 μm.

The alumina content of the first solid electrolytic substrate 31 and the second solid electrolytic substrate 41 can be measured in the following manner. First of all, the first solid electrolytic substrate 31 or the second solid electrolytic substrate 41 is separated or dissected into three sections in the thickness direction. The alumina contents of samples taken from respective separated sections of the solid electrolytic substrate are then measured by using an EPMA analyzing apparatus.

More specifically, first of all, preliminary measurement is performed to obtain characteristic X-ray intensities of standard samples (e.g., samples differentiated in the contents of alumina and zirconia) whose contents are already known. Next, a measuring object sample (i.e. the multilayered gas sensing element 1) is subjected to the measurement of characteristic X-ray intensity. In this case, the multilayered gas sensing element 1 is cut along a surface normal to the longitudinal direction of the element to expose a cross-sectional surface as shown in FIG. 1. Then, an electron beam is irradiated to an arbitrary portion to be measured, to detect the characteristic X-ray intensity which generates as an interaction between the sample and the electron beam. The measured characteristic X-ray intensity of the multilayered gas sensing element 1 is compared with the characteristic X-ray intensities of the standard samples, and further corrected to determine the alumina content. An average of the measured data obtained from three separated sections of each solid electrolytic substrate is defined as an alumina content of this solid electrolytic substrate.

Hereinafter, the arrangement of the multilayered gas sensing element 1 in accordance with this embodiment will be explained in more detail. As shown in FIG. 1, a heater pattern 22 having a heat-generating portion is formed in the heater substrate 21. The heater pattern 22 and the heater substrate 21 cooperatively arrange the ceramic heater 2. The first cell 3 of the multilayered gas sensing element 1 according to this embodiment is a sensor cell. As shown in FIG. 1, a measured gas side electrode 33 to be exposed to a measured gas is provided on one surface of the first solid electrolytic substrate 31. A reference gas side electrode 34 to be exposed to a reference gas is provided on the other surface of the first solid electrolytic substrate 31.

The second cell 4 of the multilayered gas sensing element 1 according to this embodiment is a pump cell having the capability of shifting oxygen ions between its front and reverse surfaces. The second cell 4 includes a pair of pump electrodes 421 and 422 provided on both surfaces of the second solid electrolytic substrate 41. The chamber layer 11, for forming the measured gas chamber 111, intervenes between the first cell 3 and the second cell 4. The chamber layer 11 contains zirconia. Regarding the second component, the chamber layer 11 has an intermediate content between the contents of the first solid electrolytic substrate 31 and the second solid electrolytic substrate 41.

Furthermore, a gas-permeable porous diffusion layer 12 is formed on a surface of the second solid electrolytic substrate 41, which is far from the ceramic heater 2, so as to cover the pump electrode 422. The porous diffusion layer 12 is a porous member containing zirconia as a main component.

The multilayered gas sensing element 1 can be manufactured by preparing the following green sheets:
a green sheet of the heater substrate 21 in which the heater pattern 22 is already formed;
a green sheet of the first solid electrolytic substrate 31 on the both surfaces of which the measured gas side electrode 33 and the reference gas side electrode 34 are provided;
a green sheet of the chamber layer 11 having an inner hollow space;
a green sheet of the second solid electrolytic substrate 41 on the both surfaces of which a pair of pump electrodes 421 and 422 are provided; and
a green sheet of the porous diffusion layer 12.

These green sheets are laminated and bonded together and then sintered into the multilayered gas sensing element 1.

The multilayered gas sensing element 1 whose alumina content is 95 wt. % in the heater substrate 21, 50 wt. % in the first solid electrolytic substrate 31, and 2 wt. % in the second solid electrolytic substrate 41 is one of practical examples satisfying the conditions of this embodiment.

Table 1 shows other examples satisfying the requirements of the present invention.

TABLE 1

| | Example No. | | | | | |
|---|---|---|---|---|---|---|
| | 1 | 2 | 3 | 4 | 5 | 6 |
| 2nd solid | Small | Large | Middle | Large | Middle | Small |
| electrolytic | | | | | | |
| substrate | | | | | | |
| 1st solid | Middle | Middle | Small | Small | Large | Large |
| electrolytic | | | | | | |
| substrate | | | | | | |

| | |
|---|---|
| Heater substrate | Large or Middle |

In Table 1, the expression “Large” indicates that the insulating ceramic content is equal to or larger than 80 wt. %, the expression “Middle” indicates that the insulating ceramic content is larger than 10 wt. % and less than 80 wt. %, and the expression “Small” indicates that the insulating ceramic content is less than 10 wt. %. As apparent from Table 1, the present invention includes numerous examples regardless of magnitude relationship between insulating ceramic contents of the first solid electrolytic substrate 31 and the second solid electrolytic substrate 41.

The multilayered gas sensing element according to the first embodiment brings the following functions and effects.

With respect to the alumina content, there is a difference equal to or less than 90 wt. % between the first solid electrolytic substrate 31 and the heater substrate 21. Accordingly, the strength of the first solid electrolytic substrate 31 can be enhanced. The stress acting between the first solid electrolytic substrate 31 and the heater substrate 21 can be reduced. Thus, the multilayered gas sensing element 1 according to the first embodiment can suppress warpage or crack.

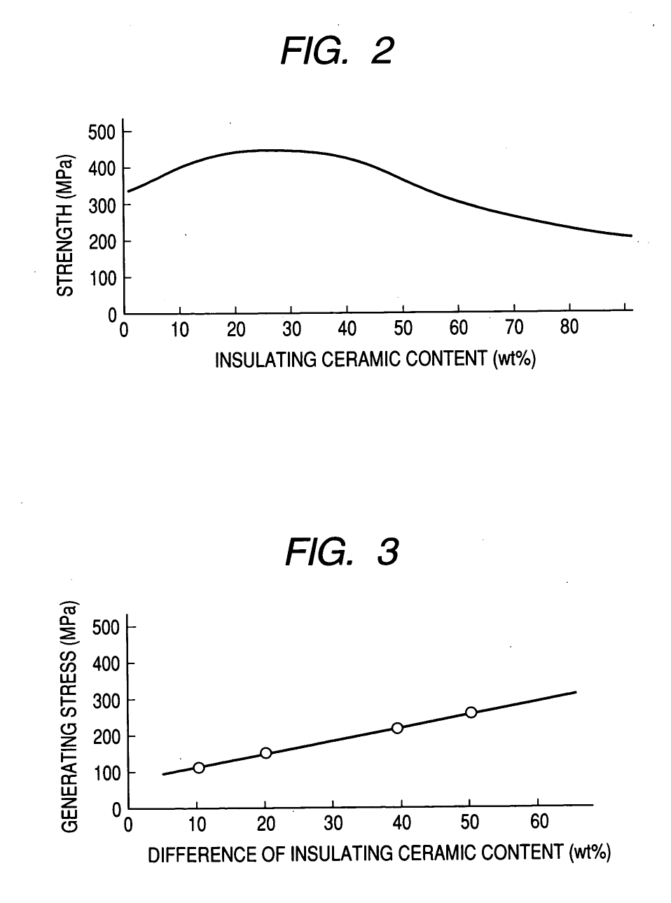

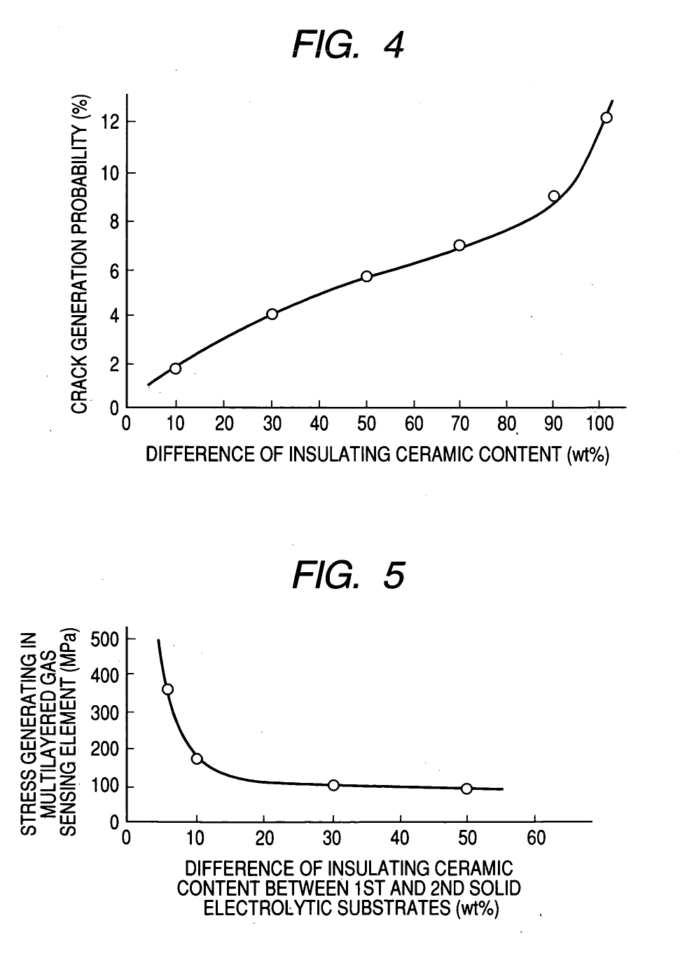

More specifically, as shown in FIG. 2, the strength of the first solid electrolytic substrate 31 can be maximized when the insulating ceramic (alumina) content is in the range from 20 to 40 wt. %. Furthermore, as shown in FIG. 3, the stress generating between the first solid electrolytic substrate 31 and the heater substrate 21 increases linearly in accordance with the difference of the insulating ceramic (alumina) content. The above two relationships derive the relationship of FIG. 4, which shows the crack generation probability in the multilayered gas sensing element 1 in relation to the difference of the insulating ceramic (alumina) content between the first solid electrolytic substrate 31 and the heater substrate 21.

From the relationship FIG. 4, it is understood that the crack generation probability reduces when the difference between the insulating ceramic (alumina) contents of the first solid electrolytic substrate 31 and the heater substrate 21 reduces. On the other hand, the crack generation probability abruptly increases when the content difference exceeds 90 wt. %. Therefore, using the first solid electrolytic substrate 31 and the heater substrate 21 whose insulating ceramic (alumina) contents are differentiated by 90 wt. % or less brings the effect of suppressing crack occurring in the multilayered gas sensing element 1.

Furthermore, according to the multilayered gas sensing element 1 according to the first embodiment, the difference between the alumina content of the second solid electrolytic substrate 41 and the alumina content of the first solid electrolytic substrate 31 is equal to or greater than 10 wt. %. Accordingly, a significant stress acts between the first solid electrolytic substrate 31 and the second solid electrolytic substrate 41. Thus, the multilayered gas sensing element 1 according to the first embodiment can decentralize a stress generating in the multilayered gas sensing element.

More specifically, when the alumina content of the second solid electrolytic substrate 41 is substantially equal to the alumina content of the first solid electrolytic substrate 31, there will be the possibility that all of the stress concentrates between the heater substrate 21 and the first solid electrolytic substrate 31. Hence, as described above, differentiating the alumina content of the second solid electrolytic substrate 41 from the alumina content of the first solid electrolytic substrate 31 can bring the effects of reducing the stress concentrating between the heater substrate 21 and the first solid electrolytic substrate 31 and suppressing the generation of warpage or crack occurring in the multilayered gas sensing element 1.

As shown in FIG. 5, the multilayered gas sensing element 1 is subjected to a large stress acting between the second solid electrolytic substrate 41 and the first solid electrolytic substrate 31 when the alumina content difference is less than 10 wt. %. However, when the alumina content difference exceeds 10 wt. %, the stress generating in the multilayered gas sensing element 1 can be reduced. The relationships shown in FIGS. 2 to 5 are based on the data obtained when the insulating ceramic (alumina) content of the heater substrate 21 is equal to or less than 50 wt. %.

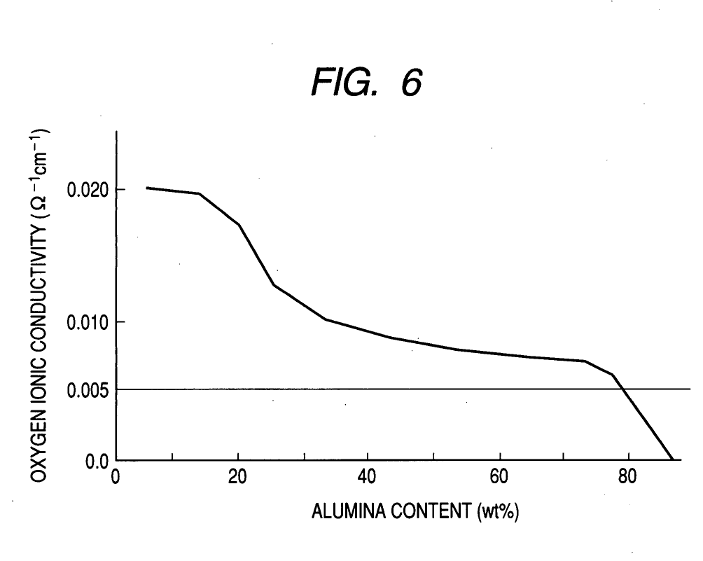

Furthermore, according to the multilayered gas sensing element 1 of the first embodiment, the alumina content of at least one of the first solid electrolytic substrate 31 and the second solid electrolytic substrate 41 is equal to or less than 80 wt. %. Therefore, as shown in FIG. 6, at least one of the first solid electrolytic substrate 31 and the second solid electrolytic substrate 41 can maintain sufficient oxygen ionic conductivity (e.g. 0.005 Ω⁻¹ cm⁻¹ or more). The sensor resistance can be reduced to a small value (e.g. 200% or less). Thus, the multilayered gas sensing element 1 can secure sufficient sensor output.

More specifically, as shown in FIG. 6, the oxygen ionic conductivity of the solid electrolytic substrate decreases when the alumina content exceeds 10 wt. %. However, it is possible to maintain satisfactory oxygen ionic conductivity when the alumina content exceeds is equal to or less than 80 wt. %. Therefore, using at least one of the first solid electrolytic substrate 31 and the second solid electrolytic substrate 41 whose alumina content is equal or less than 80 wt. % can bring the effect of securing the oxygen ionic conductivity. As a result, the multilayered gas sensing element 1 can secure sufficient sensor output.

For example, the pump cell output can be used as a sensor output. Accordingly, it is possible to secure satisfactory sensor output by maintaining higher oxygen ionic conductivity for the solid electrolytic substrate in the pump cell, even if the solid electrolytic substrate of the sensor cell has lower oxygen ionic conductivity.

Furthermore, the heater substrate 21 contains alumina by 50 wt. % or more. Thus, the heater substrate 21 can secure sufficient insulation properties. Furthermore, each of the first solid electrolytic substrate 31 and the second solid electrolytic substrate 41 has the thickness of 10 to 500 μm. Accordingly, it is possible to promptly activate the first cell 3 and the second cell 4.

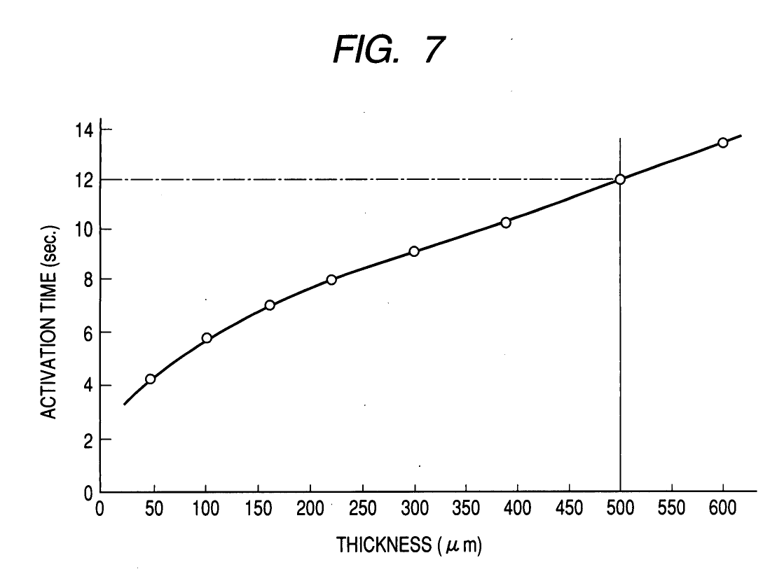

More specifically, for example, as shown in FIG. 7, the activation time of the first cell 3 or the second cell 4 decreases when the thickness of the first solid electrolytic substrate 31 or the second solid electrolytic substrate 41 decreases. The activation time of 10 seconds or less can be obtained when the thickness of the first solid electrolytic substrate 31 or the second solid electrolytic substrate 41 is equal to or less than 500 μm. The activation time represents a time measured after electric power is supplied to the ceramic heater 2, as a time required until the output of the first cell 3 or the second cell 4 reaches 95% of the stable level. The activation time was measured under the conditions that a measured gas has an air-fuel ratio (A/F) of approximately 18 and the temperature is a room temperature (approximately 20° C.).

As described above, the first embodiment provides a multilayered gas sensing element capable of suppressing warpage or crack and securing sufficient sensor output.

### Second Embodiment

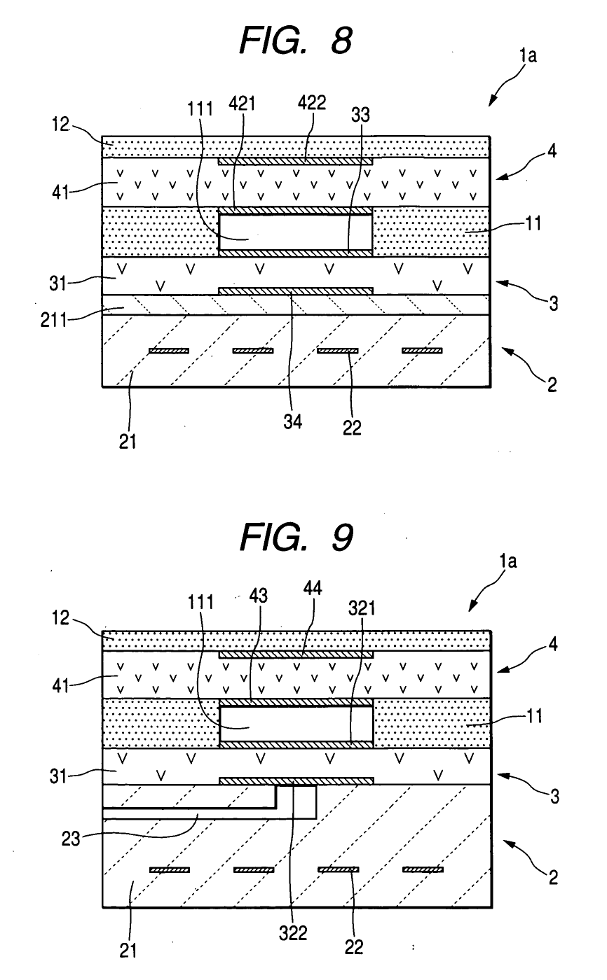

As shown in FIG. 8, this embodiment provides a multilayered gas sensing element 1a characterized in that the heater substrate 21 has a first component containing layer 211 at a position closest to the first solid electrolytic substrate 31. The first component containing layer 211 contains zirconia serving as the first component of the present invention. Furthermore, the first component containing layer 211 has the thickness of 3 to 600 μm. The rest of the multilayered gas sensing element 1a is structurally identical with the multilayered gas sensing element 1 explained in the first embodiment.

According to this arrangement, the difference between a heat shrinkage factor of the first solid electrolytic substrate 31 and a heat shrinkage factor of the heater substrate 21 can be decreased. Thus, the multilayered gas sensing element 1a of this embodiment can suppress warpage or crack. Using the first component containing layer 311 having the zirconia content of 2 to 40 wt. % can bring the effect of sufficiently securing insulation properties of the heater substrate 31 and suppressing warpage or crack occurring in the multilayered gas sensing element 1a. Furthermore, this embodiment can bring the same functions and effects as those of the first embodiment.

### Third Embodiment

As shown in FIG. 9, this embodiment provides a multilayered gas sensing element 1b characterized in that the first cell 3 is a pump cell having a pair of pump electrodes 321 and 322 provided on both surfaces of the first solid electrolytic substrate 31 to cause a specific gas to shift between these pump electrodes 321 and 322. The pump cell (i.e. first cell 3) is located adjacent to the heater substrate 21. And, the heater substrate 21 has a passage 23 extending from the pump electrode 322 to the outside of the multilayered gas sensing element 1b. According to the multilayered gas sensing element 1b of this embodiment, the oxygen can shift between the measured gas chamber 111 filled with the measured gas and the outside of the multilayered gas sensing element 1b. Thus, the oxygen concentration in the measured gas chamber 111 can be controlled.

Furthermore, according to the multilayered gas sensing element 1b of this embodiment, the second cell 4 is a sensor cell including a measured gas side electrode 43 and a reference gas side electrode 44 disposed on both surfaces of the second solid electrolytic substrate 41. Therefore, as shown in FIG. 9, the ceramic heater 2, the pump cell (i.e. the first cell 3), and the chamber layer 11, the sensor cell (i.e. the second cell 4), and the porous diffusion layer 12 are laminated in this order to arrange multilayered gas sensing element 1b of the third embodiment. The rest of the multilayered gas sensing element 1b is structurally identical with the multilayered gas sensing element 1 explained in the first embodiment. Thus, the multilayered gas sensing element 1b of this embodiment can suppress warpage or crack and secure sufficient sensor output. Furthermore, this embodiment can bring the same functions and effects as those of the first embodiment.

### Fourth Embodiment

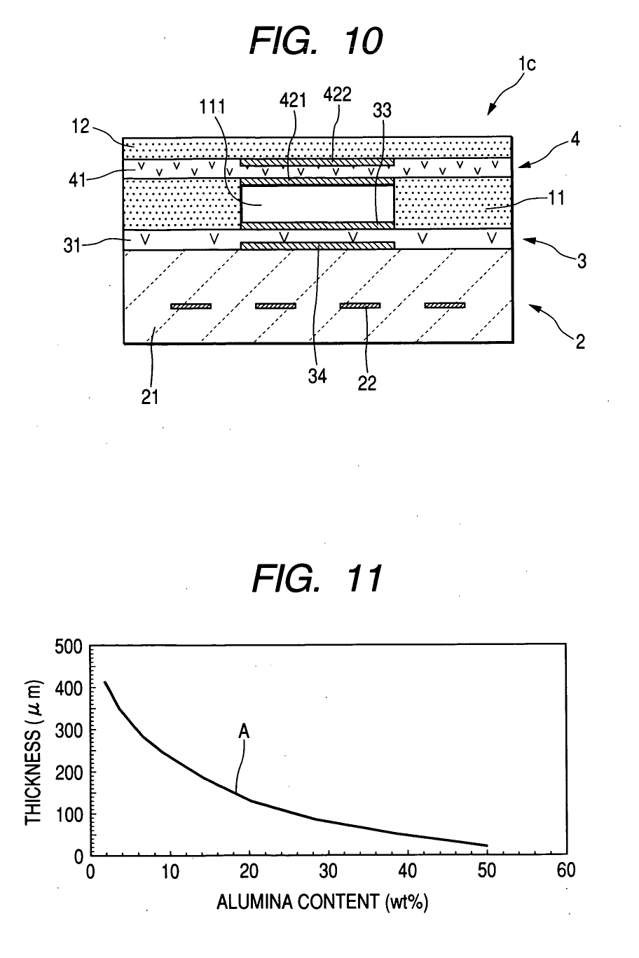

As shown in FIG. 10, this embodiment provides a multilayered gas sensing element 1c characterized in that the first solid electrolytic substrate 31 and the second solid electrolytic substrate 41 have smaller thicknesses. The thickness of the solid electrolytic substrate 21 is, for example, 50 μm. The rest of the multilayered gas sensing element 1c is structurally identical with the multilayered gas sensing element 1 explained in the first embodiment.

According to this arrangement, both the first cell 3 and the second cell 4 can be promptly activated. As shown in FIG. 7, using the first solid electrolytic substrate 31 or the second solid electrolytic substrate 41 having a smaller thickness brings the effect of shortening the activation time of the first cell 3 or the second cell 4. For example, when the thickness is 50 μm, the activation time is approximately 4 seconds. Furthermore, using the first solid electrolytic substrate 31 or the second solid electrolytic substrate 41 having a smaller thickness brings the effect of maintaining satisfactory sensor output even if the alumina content is large in the solid electrolytic substrate 31 or 41. FIG. 11 is a graph showing the relationship between the alumina content of the solid electrolytic substrate and the thickness of the solid electrolytic substrate required to obtain a predetermined sensor output. More specifically, satisfying the conditions of the curve ‘A’ shown in FIG. 11 makes it possible to produce a sensor output obtainable when the solid electrolytic substrate 21 has the alumina content of 2 wt. % and the thickness of 400 μm. Furthermore, this embodiment can bring the same functions and effects as those of the first embodiment.

### Experimental Data

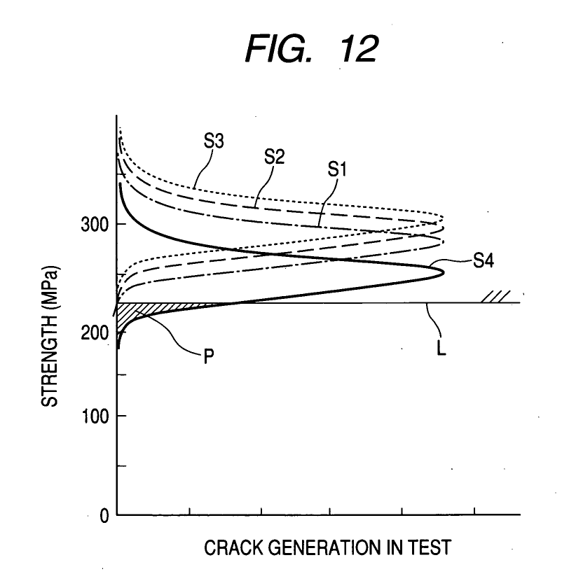

FIG. 12 is a graph showing experimental data comparing the strengths of the multilayered gas sensing elements according to the present invention with the strength of a conventional multilayered gas sensing element. The tested samples of the present invention were structurally identical with the multilayered gas sensing element 1 of the first embodiment. Two samples (i.e. sample 1 and sample 2) were differentiated in the alumina contents of the first solid electrolytic substrate 31 and the second solid electrolytic substrate 41.

More specifically, the alumina content of the first solid electrolytic substrate 31 was 10 wt. % in the sample 1, 30 wt. % in the sample 2, and 50 wt. % in the sample 3. In each of respective samples 1, 2, and 3, the alumina content of the second solid electrolytic substrate 41 was differentiated from the alumina content of the first solid electrolytic substrate 31 by an amount of 10 wt. %. Furthermore, in each of the samples 1, 2, and 3, the alumina content of the heater substrate 21 was 100 wt. %.

On the other hand, a comparable sample (i.e. conventional multilayered gas sensing element) has the arrangement identical with the multilayered gas sensing element 1 of the first embodiment. More specifically, the alumina contents of the first solid electrolytic substrate 31 and the second solid electrolytic substrate 41 were 0 wt. %.

For evaluation tests, a total of 100 test samples were prepared for each type (i.e. for respective samples 1 to 3 and the comparable sample). These test samples were sintered at 1,500° C. and then gradually cooled down to the room temperature. In the process of gradually decreasing the temperature, the relationship between the magnitude of stress and the generation of crack were checked. The generation of crack was checked by measuring the insulation resistance between the measured gas side electrode 33 and the reference gas side electrode 34 of the first solid electrolytic substrate 31 or by measuring the insulation resistance between the pump electrodes 421 and 422 of the second solid electrolytic substrate 41 in multilayered gas sensing element. More specifically, when the insulation resistance between the measured gas side electrode 33 and the reference gas side electrode 34 is equal to or less than 500 MΩ, or when the insulation resistance between the pump electrodes 421 and 422 is equal to or less than 500 MΩ, it was judged that this sample has caused any crack.

FIG. 12 is a graph showing test results.

In this graph, the curve S1 represents the test data of sample 1, the curve S2 represents the test data of sample 2, the curve S3 represents the test data of sample 3, and the curve S4 represents the test data of the comparable sample (i.e. conventional one). Furthermore, the straight line L represents the stress (approximately 225 MPa) acting in the manufacturing processes of the multilayered gas sensing element. From the test results shown in FIG. 12, it is understood that the test samples according to the present invention (i.e. samples 1, 2, and 3) are excellent in strength compared with the comparable sample (i.e. conventional one). In other words, the multilayered gas sensing elements according to the present invention showed the excellent capability of enduring the stress (i.e. straight line L) acting in the manufacturing processes of the multilayered gas sensing element. On the other hand, the comparable sample (i.e. conventional one) showed insufficient strength in the hatched region P. Thus, there will be the possibility that the conventional multilayered gas sensing element may cause any crack during the manufacturing processes thereof.

Furthermore, the sample 2 is superior in strength to the sample 1, and the sample 3 is superior in strength to the sample 2. From the above results, it is understood that increasing the alumina contents in the first solid electrolytic substrate 31 and the second solid electrolytic substrate 41 so as to approach to the alumina content of the heater substrate 21 brings the effect of enhancing the strength of the multilayered gas sensing element. As described above, the present invention can obtain a multilayered gas sensing element having excellent strength.

As another evaluation tests, the sensor resistance of the multilayered gas sensing element according to the present invention was measured. This evaluation test was conducted based on a test sample whose first solid electrolytic substrate 31 has the alumina content of 80 wt. %. To measure the sensor resistance of this test sample, a constant voltage (e.g. 0.5 V) is applied between the measured gas side electrode 23 and the reference gas side electrode 24 of the multilayered gas sensing element 1 shown in FIG. 1 in the air at the temperature of 800° C. The current value flowing between these electrodes was measured to obtain the relationship between the applied voltage and the current value to be measured in the process of the current reaching to the limiting or critical current. Then, the resistance value was obtained from this relationship.

As a result of this evaluation test, it was confirmed that the sensor resistance of the multilayered gas sensing element 1 is equal to or less than 200 Ω. Furthermore, from this result, it is known that the solid electrolytic substrate 31 has the oxygen ionic conductivity of 0.005 Ω⁻¹ cm⁻¹ or more.

As apparent from the foregoing description, the multilayered gas sensing element according to the present invention possesses sufficient oxygen ionic conductivity and accordingly can produce sufficient sensor output.

1. A multilayered gas sensing element comprising a ceramic heater, a first cell, and a second cell which are laminated integrally, said ceramic heater having a heater substrate containing an insulating ceramic as a main component, said first cell having a first solid electrolytic substrate containing a first component serving as a main component of an ionic conductive solid electrolyte, and said second cell having a second solid electrolytic substrate containing said first component, wherein
each of said first solid electrolytic substrate and said second solid electrolytic substrate contains a second component,
a thermal expansion coefficient of said second component is different from a thermal expansion coefficient of said insulating ceramic by an amount equal to or less than 2.0×10⁻⁶° C.⁻¹,
a difference between the content of said second component contained in said first solid electrolytic substrate and the content of said insulating ceramic contained in said heater substrate is equal to or less than 90 wt. %,
a difference between the content of said second component contained in said second solid electrolytic substrate and the content of said second component contained in said first solid electrolytic substrate is equal to or greater than 10 wt. %, and
the content of said second component contained in at least one of said first solid electrolytic substrate and said second solid electrolytic substrate is equal to or less than 80 wt. %.

2. The multilayered gas sensing element in accordance with claim 1, wherein a difference between the content of said second component contained in said first solid electrolytic substrate and the content of said insulating ceramic contained in said heater substrate is equal to or less than 70 wt. %.

3. The multilayered gas sensing element in accordance with claim 1, wherein a difference between the content of said second component contained in said first solid electrolytic substrate and the content of said insulating ceramic contained in said heater substrate is equal to or less than 50 wt. %.

4. The multilayered gas sensing element in accordance with claim 1, wherein a difference between the content of said second component contained in said second solid electrolytic substrate and the content of said second component contained in said first solid electrolytic substrate is equal to or greater than 20 wt. %.

5. The multilayered gas sensing element in accordance with claim 4, wherein said heater substrate contains said insulating ceramic by an amount equal to or greater than 50 wt. %.

6. The multilayered gas sensing element in accordance with claim 1, wherein said first cell is a pump cell having a pair of pump electrodes provided on both surfaces of said first solid electrolytic substrate to cause a specific gas to shift between said pump electrodes, and
said heater substrate has a passage extending from said pump electrode to an outside of said multilayered gas sensing element.

7. The multilayered gas sensing element in accordance with claim 1, wherein said first solid electrolytic substrate has a thickness of 10 to 500 μm.

8. The multilayered gas sensing element in accordance with claim 1, wherein said second solid electrolytic substrate has a thickness of 10 to 500 μm.

9. A multilayered gas sensing element comprising a ceramic heater, a first cell, and a second cell which are laminated integrally, said ceramic heater having a heater substrate containing an insulating ceramic as a main component, said first cell having a first solid electrolytic substrate containing a first component serving as a main component of an ionic conductive solid electrolyte, and said second cell having a second solid electrolytic substrate containing said first component, wherein
said heater substrate has a first component containing layer at a position closest to said first solid electrolytic substrate, and
said first component containing layer contains said first component.

10. The multilayered gas sensing element in accordance with claim 9, wherein the content of said first component contained in said first component containing layer is 2 to 40 wt. %.

11. The multilayered gas sensing element in accordance with claim 9, wherein said first solid electrolytic substrate has a thickness of 10 to 500 μm.

12. The multilayered gas sensing element in accordance with claim 9, wherein said second solid electrolytic substrate has a thickness of 10 to 500 μm.
